(19) United States
(12) Patent Application Publication
(10) Pub. No.: US 2025/0039995 A1
(43) Pub. Date: Jan. 30, 2025

(54) HEATING ELEMENT, HEATER, HEATER MODULE, AND HEATING ELEMENT MANUFACTURING METHOD

(71) Applicant: TOMOEGAWA CO., LTD., Tokyo (JP)

(72) Inventors: Shuhei HATANO, Shizuoka (JP); Yousuke SUGAWARA, Shizuoka (JP); Hideki MORIUCHI, Shizuoka (JP)

(21) Appl. No.: 18/551,435

(22) PCT Filed: Feb. 8, 2022
(86) PCT No.: PCT/JP2022/004786

§ 371 Date: Sep. 20, 2023

(30) Foreign Application Priority Data
Mar. 29, 2021 (JP) 2021-056289
Mar. 29, 2021 (JP) 2021-056290

(51) Int. Cl. H05B 3/34; H05B 1/02

(52) U.S. Cl. CPC H05B 3/34; H05B 1/0244; H05B 2203/003; H05B 2203/017

(57) ABSTRACT

In a heating element (46) constituting a belt-shaped heater wire, the heater wire is configured such that short metal fibers are at least partially bonded to each other. A magnitude of a ratio of resistivity of the heating element (46) measured along a second direction orthogonal to a longitudinal direction of the heating element (46), to resistivity of the heating element (46) measured along a first direction which is the longitudinal direction of the heating element (46), is within a range of 0.9 to 1.1, and a magnitude of a ratio of the resistivity of the heating element (46) measured along the first direction, to resistivity of the heating element (46) measured along a third direction making an angle of 45° with respect to the first direction at a surface of the heating element (46), is not greater than 0.8 or not less than 1.2.

### TECHNICAL FIELD

The present invention relates to a heating element constituting a belt-shaped heater wire extending along a flat surface, a heater, a heater module, and a heating element manufacturing method.

### BACKGROUND ART

Hitherto, various types of sheet-shaped heaters have been known. For example, Japanese Laid-Open Patent Publication No. 2015-122180 (JP2015-122180A) discloses a flexible heater that includes a flexible high heat-transfer sheet made of heat-resistant and good heat-conductive fibers such as metal fibers and a heater wire placed so as to be close to or in contact with one surface of the high heat-transfer sheet and that is used such that the other surface of the high heat-transfer sheet faces an object to be heated. Such a heater allows stable heating to a predetermined temperature within a very wide temperature range, can prevent melting or breaking of the heater wire due to excessive temperature rising, and is suitable for use in heating a mold for molding or an extruder.

### SUMMARY OF THE INVENTION

The above-described conventional heater includes the high heat-transfer sheet made of metal fibers or the like. In the case of manufacturing such a high heat-transfer sheet by a wet-type sheetmaking machine, the longitudinal direction of the metal fibers contained in the high heat-transfer sheet generally coincides with the conveyance direction of a conveyor, causing the metal fibers to be oriented. In this case, non-uniform electrical conductivity occurs in the high heat-transfer sheet, so that there is a problem that when a current is applied to the high heat-transfer sheet, heat generation is non-uniform on a part of the sheet.

The present invention has been made in consideration of such circumstances, and an object of the present invention is to provide a heating element, a heater, a heater module, and a heating element manufacturing method that can prevent heat generation from being non-uniform.

A heating element of the present invention is a heating element constituting a belt-shaped heater wire, wherein
the heater wire is configured such that short metal fibers are at least partially bonded to each other,
a magnitude of a ratio of resistivity of the heating element measured along a second direction orthogonal to a longitudinal direction of the heating element, to resistivity of the heating element measured along a first direction which is the longitudinal direction of the heating element, is within a range of 0.9 to 1.1, and
a magnitude of a ratio of the resistivity of the heating element measured along the first direction, to resistivity of the heating element measured along a third direction making an angle of 45° with respect to the first direction at a surface of the heating element, is not greater than 0.8 or not less than 1.2.

A heater of the present invention includes:
the above heating element; and
an insulator stacked on at least one surface of the heating element.

A heater module of the present invention is a heater module including the above heater and a temperature regulator(s), wherein
the heater and the temperature regulator(s) are placed so as to be aligned in series in a flow direction of a to-be-heated fluid.

A heating element manufacturing method of the present invention is a method for manufacturing a heating element constituting a belt-shaped heater wire, the method including:
a step of producing a metal fiber sheet by sheetmaking; and
a step of cutting the metal fiber sheet produced by sheetmaking, into a quadrangular shape including a side extending in a fourth direction making an angle within a range of 30° to 60° with respect to a sheetmaking direction and a side extending in a fifth direction making an angle within a range of 80° to 100° with respect to the fourth direction.

### Effects of the Invention

The heating element, the heater, the heater module, and the heating element manufacturing method of the present invention can prevent heat generation from being non-uniform.

### BRIEF DESCRIPTION OF THE DRAWINGS

FIG. 1 is a schematic configuration diagram schematically showing a configuration of a heater module of a first example according to an embodiment of the present invention.

FIG. 2 is a schematic configuration diagram schematically showing a configuration of a heater module of a second example according to the embodiment of the present invention.

FIG. 3 is a schematic configuration diagram schematically showing a configuration of a heater module of a third example according to the embodiment of the present invention.

FIG. 4 is a configuration diagram of a heater used in each heater module according to the embodiment of the present invention.

FIG. 5 is a schematic configuration diagram schematically showing a configuration of a wet-type sheetmaking machine used for manufacturing a heating element included in the heater shown in FIG. 4.

FIG. 6 is a diagram illustrating a method for cutting a metal fiber sheet produced by the wet-type sheetmaking machine shown in FIG. 5.

FIG. 7 is a diagram illustrating a conventional method for cutting the metal fiber sheet.

FIG. 8 is a diagram illustrating another conventional method for cutting the metal fiber sheet.

FIG. 9 is a diagram showing another configuration of the heating element included in the heater used in the heater module according to the embodiment of the present invention.

FIG. 10 is a diagram showing still another configuration of the heating element included in the heater used in the heater module according to the embodiment of the present invention.

FIG. 11 is a diagram showing still another configuration of the heating element included in the heater used in the heater module according to the embodiment of the present invention.

### DESCRIPTION OF THE PREFERRED EMBODIMENTS

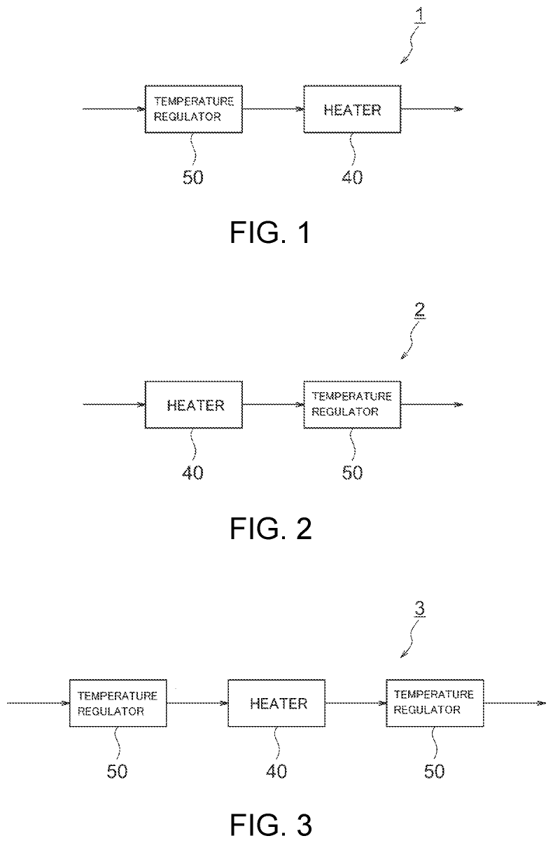

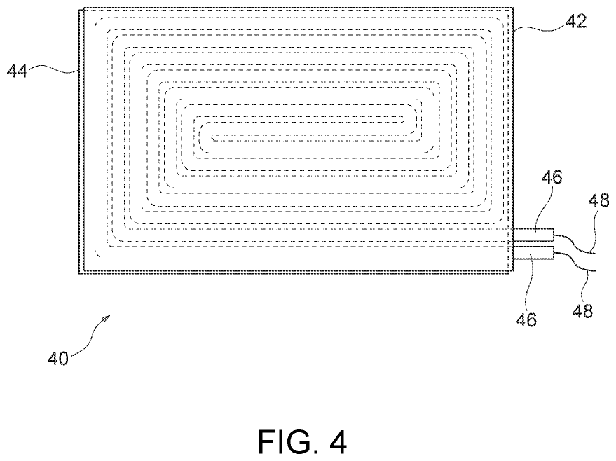

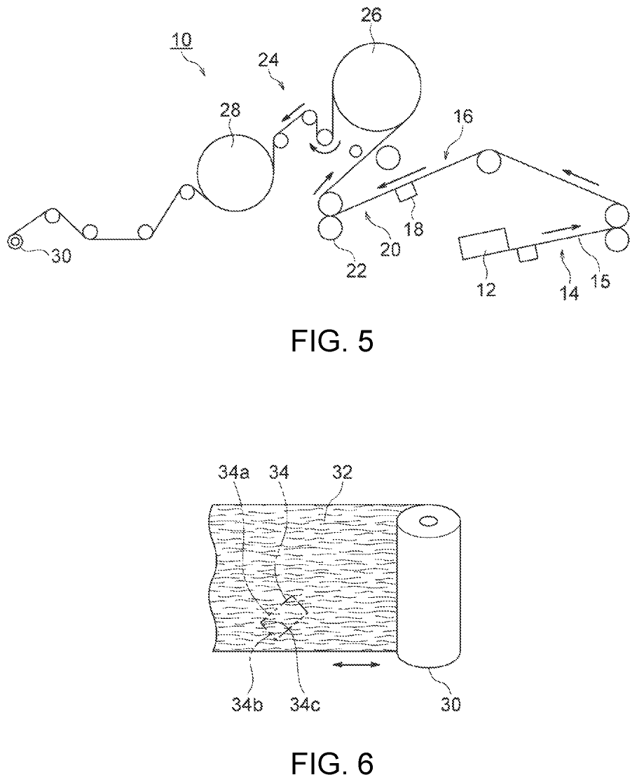

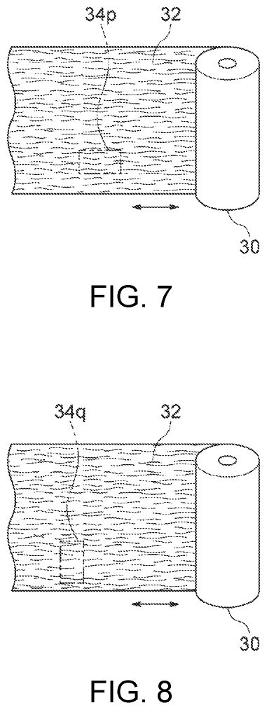

Hereinafter, an embodiment of the present invention will be described with reference to the drawings. FIG. 1 to FIG. 3 are schematic configuration diagrams schematically showing configuration examples of various heater modules according to the embodiment of the present invention. FIG. 4 is a configuration diagram of a heater according to the present embodiment, and FIG. 5 is a schematic configuration diagram schematically showing a configuration of a wet-type sheetmaking machine used for manufacturing a heating element included in the heater shown in FIG. 4. FIG. 6 is a diagram illustrating a method for cutting a metal fiber sheet produced by the wet-type sheetmaking machine shown in FIG. 5. FIG. 7 and FIG. 8 are each a diagram illustrating a conventional method for cutting the metal fiber sheet. In FIG. 6 to FIG. 8, short metal fibers contained in the metal fiber sheet are indicated by thin lines to help understanding of the orientation of the short metal fibers.

As shown in FIG. 1 to FIG. 3, heater modules 1, 2, and 3 according to the present embodiment each include a heater 40 and a temperature regulator(s) 50, and the heater 40 and the temperature regulator(s) 50 are placed so as to be aligned in series in a flow direction (indicated by arrows in FIG. 1 to FIG. 3) of a to-be-heated fluid such as a liquid or a gas. In the heater module 1 according to a first example shown in FIG. 1, the temperature regulator 50 and the heater 40 are placed in this order from the upstream side in the flow direction of the to-be-heated fluid. That is, the heater 40 is placed downstream of the temperature regulator 50 in the flow direction of the to-be-heated fluid. In addition, in the heater module 2 according to a second example shown in FIG. 2, the heater 40 and the temperature regulator 50 are placed in this order from the upstream side in the flow direction of the to-be-heated fluid. That is, the heater 40 is placed upstream of the temperature regulator 50 in the flow direction of the to-be-heated fluid. Moreover, in the heater module 3 according to a third example shown in FIG. 3, the temperature regulator 50, the heater 40, and the temperature regulator 50 are placed in this order from the upstream side in the flow direction of the to-be-heated fluid.

Each temperature regulator 50 adjusts the temperature of the to-be-heated fluid to a temperature within a predetermined range that is set in advance, by heating or cooling the to-be-heated fluid. A known temperature regulator is used as such a temperature regulator 50. For example, a temperature regulator having a simple known configuration using cold or hot water may be used as the temperature regulator 50, or a temperature regulator having a configuration using a metal fiber structure may be used as the temperature regulator 50 in order to increase heat transfer efficiency.

In the temperature regulator 50, a heat storage material may be used in order to adjust the temperature of the to-be-heated fluid to a temperature within the predetermined range. As the heat storage material, a type that stores the heat added to the heat storage material, as latent heat when a solid-liquid phase transition occurs, can be used, or a type that stores the heat added to the heat storage material, as latent heat when a solid-solid phase transition occurs, can be used.

Examples of the heat storage material using the latent heat of a solid-liquid phase transition include: single-component heat storage materials such as water (ice), paraffin-based materials, inorganic salts including alkali metal hydroxides, magnesium hydroxide, beryllium hydroxide, alkaline earth metal hydroxides, nitrates, etc., and inorganic hydrated salts including sodium acetate trihydrate, etc.; and mixtures of multiple components such as mixtures of inorganic salts or inorganic hydrated salts including a mixture of magnesium nitrate hexahydrate and magnesium chloride hexahydrate, etc., mixtures of organic compounds including a mixture of lauric acid and capric acid, etc., and mixtures of inorganic salts and organic compounds including a mixture of ammonium nitrate and urea, etc. In addition, as the paraffin-based materials, for example, n-pentadecane, which is an n-paraffin-based heat storage material, and a material composed of an elastomer and paraffin can be used.

Examples of the heat storage material using the latent heat of a solid-solid phase transition include: organic compounds such as polyethylene glycol-copolymerized crosslinked products; transition metal ceramics such as LiMnO4, LiVS2, LiVO2, NaNiO2, LiRh204, V2O3, V4O7, V6O11, Ti4O7, SmBaFe2O5, EuBaFe2O5, GdBaFe2O5, TbBaFe2O5, DyBaFe2O5, HoBaFe2O5, YBaFe2O5, PrBaCo2O5.5, DyBaCo2O5.54, HoBaCo2O5.48, and YBaCo2O5.49; and vanadium dioxide (VO2) in which vanadium is partially replaced by a metal such as niobium (Nb), molybdenum (Mo), ruthenium (Ru), tantalum (Ta), tungsten (W), rhenium (Re), osmium (Os), and iridium (Ir). The vanadium dioxide in which vanadium is partially replaced by the metal can be represented as V1−xMxO2, where M is the metal that replaces vanadium and x is the amount of the metal that replaces vanadium. Here, x is a decimal greater than 0 and less than 1.

The heater 40 uniformly heats the to-be-heated fluid such that the temperature of the to-be-heated fluid becomes a temperature within a predetermined narrow range.

In the heater module 1 according to the first example shown in FIG. 1, since the temperature regulator 50 and the heater 40 are placed in this order from the upstream side in the flow direction of the to-be-heated fluid, after the temperature of the to-be-heated fluid is adjusted to a temperature within the predetermined range by the temperature regulator 50, the to-be-heated fluid can be uniformly heated by the heater 40 such that the temperature of the to-be-heated fluid becomes a temperature within the predetermined narrow range.

In the heater module 2 according to the second example shown in FIG. 2, since the heater 40 and the temperature regulator 50 are placed in this order from the upstream side in the flow direction of the to-be-heated fluid, after the to-be-heated fluid is uniformly heated by the heater 40 such that the temperature of the to-be-heated fluid becomes a temperature within the predetermined narrow range, the temperature of the to-be-heated fluid can be adjusted to a temperature within the predetermined range by the temperature regulator 50.

In the heater module 3 according to the third example shown in FIG. 3, since the temperature regulator 50, the heater 40, and the temperature regulator 50 are placed in this order from the upstream side in the flow direction of the to-be-heated fluid, after the temperature of the to-be-heated fluid is adjusted to a temperature within the predetermined range by the temperature regulator 50 and the to-be-heated fluid is uniformly heated by the heater 40 such that the temperature of the to-be-heated fluid becomes a temperature within the predetermined narrow range, the temperature of the to-be-heated fluid can be further adjusted to a temperature within the predetermined range by the temperature regulator 50.

Next, the details of the configuration of the heater 40 will be described. As shown in FIG. 4, the heater 40 includes a pair of insulating nonwoven fabric sheets 42 and 44 (insulators), a heating element 46 interposed between the pair of nonwoven fabric sheets 42 and 44, and lead wires 48 attached to both end portions of the heating element 46, respectively.

Each of the nonwoven fabric sheets 42 and 44 is made of an insulating and heat-conductive material. As such a material, for example, a PET/PE composite nonwoven fabric is used.

The heating element 46 is composed of a belt-shaped heater wire. As shown in FIG. 4, the heater wire has a spiral shape. The heater wire is configured such that short metal fibers are at least partially bonded to each other. As the short metal fibers, for example, at least one type of fibers out of copper fibers, stainless steel fibers, nickel fibers, aluminum fibers, and alloy fibers thereof is used. In particular, stainless steel fibers are preferably used as the short metal fibers. This is because stainless steel fibers have excellent balance between cost and rigidity, plastic deformability, and heat transfer properties. In addition, the lengths of the short metal fibers are preferably within the range of 2 to 20 mm, more preferably within the range of 5 to 17 mm, and further preferably within the range of 8 to 14 mm. The lengths of the short metal fibers can be confirmed by actual measurement through photographic observation of the heating element 46 using an SEM, an optical microscope, or the like. A method for manufacturing the heating element 46 composed of such a belt-shaped heater wire will be described later.

The longitudinal direction of the heating element 46 refers to the direction in which the long sides of a virtual substantial rectangle occupied by the heater wire having a spiral shape extend, and the right-left direction in FIG. 4 corresponds to the longitudinal direction of the heating element 46. The belt-shaped heater wire in the heating element 46 includes portions extending in the longitudinal direction of the heating element 46 and portions extending in a direction (i.e., the up-down direction in FIG. 4) orthogonal to the longitudinal direction of the heating element 46.

A power supply such as a battery which is not shown is attached to the lead wires 48. When a current is applied to the lead wires 48 by the power supply, the heating element 46 generates heat.

Next, the method for manufacturing the heating element 46 will be described with reference to FIG. 5. FIG. 5 is a schematic configuration diagram schematically showing a configuration of a wet-type sheetmaking machine 10 used for manufacturing the heating element 46.

As shown in FIG. 5, the wet-type sheetmaking machine 10 includes a headbox 12, a sheetmaking part 14, a dehydrating part 16, a pressing part 20, a drying part 24, and a winding part 30. A slurry containing short metal fibers and water is supplied to the headbox 12. At the sheetmaking part 14, the slurry supplied to the headbox 12 is made into a sheet on a conveyor 15. At the sheetmaking part 14, the slurry flows along a sheetmaking direction which is the movement direction of the conveyor 15 (indicated by arrows in FIG. 5), whereby the short metal fibers are also oriented along the movement direction of the conveyor 15. Thus, in wet-type sheetmaking by the wet-type sheetmaking machine 10, the short metal fibers are oriented in a metal fiber sheet.

At the dehydrating part 16, the sheet made on the conveyor 15 is dehydrated. Specifically, the dehydrating part 16 is provided with a suction box 18, and moisture is sucked from the sheet by the suction box 18. At the pressing part 20, the sheet on the conveyor 15 is pressed by nip rollers 22. The drying part 24 is provided with a Yankee dryer roll 26 and an after-dryer roll 28, and the sheet on the conveyor 15 is dried by the Yankee dryer roll 26 and the after-dryer roll 28. The sheet dried by the drying part 24 is wound by the winding part 30.

Before or after the sheet is wound by the winding part 30, the sheet is sintered in a vacuum or a non-oxidizing atmosphere at a temperature equal to or lower than the melting point of the metal fibers. Through such a sintering step, the short metal fibers are bonded and entangled with each other, whereby the strength of a metal fiber structure after sintering can be increased.

As shown in FIG. 6, a produced metal fiber sheet 32 is unwound from the winding part 30 and cut into a quadrangular shape (indicated by an alternate long and two short dashes line in FIG. 6) by a laser or the like. At this time, a first side 34a of the quadrangular shape is formed so as to make an angle within the range of 30° to 60°, preferably an angle within the range of 40° to 50°, and particularly preferably an angle of about 45° with respect to the sheetmaking direction (indicated by an arrow in FIG. 6), and a second side 34b of the quadrangular shape is formed so as to make an angle within the range of 80° to 100°, preferably an angle within the range of 85° to 95°, and particularly preferably an angle of about 90° with respect to the first side 34a. That is, an angle 34c in FIG. 6 is an angle within the range of 80° to 100°, preferably within the range of 85° to 95°, and particularly preferably about 90°. Accordingly, in a metal fiber sheet 34 cut into the quadrangular shape, the short metal fibers are oriented in a direction making an angle of 30° to 60° with respect to the first side 34a, and are also oriented in a direction making an angle of 30° to 60° with respect to the second side 34b. Cutting the metal fiber sheet 32 into the quadrangular shape includes cutting the metal fiber sheet 32 into a parallelogram shape, a rhombus shape, or a rectangular shape.

Then, the metal fiber sheet 34 cut into the quadrangular shape is further cut into a spiral shape by a laser or the like to produce a belt-shaped heater wire. Thus, the heating element 46 shown in FIG. 4 is manufactured.

As described above, the metal fiber sheet 32 unwound from the winding part 30 is cut into a quadrangular shape that includes the first side 34a making an angle within the range of 30° to 60° with respect to the sheetmaking direction and the second side 34b making an angle within the range of 80° to 100° with respect to the first side 34a. Therefore, the short metal fibers are also oriented obliquely to the direction in which the belt-shaped heater wire constituting the heating element 46 extends. That is, in the metal fiber sheet 34 cut into the quadrangular shape, the short metal fibers are oriented in a direction making an angle of 30° to 60° with respect to the first side 34a, that is, the longitudinal direction of the heating element 46, and are also oriented in a direction making an angle of 30° to 60° with respect to the second side 34b, that is, the direction orthogonal to the longitudinal direction of the heating element 46. In addition, the belt-shaped heater wire includes portions extending in the longitudinal direction of the heating element 46 and portions extending in the direction (i.e., the up-down direction in FIG. 4) orthogonal to the longitudinal direction of the heating element 46. Therefore, the short metal fibers are also oriented obliquely to the direction in which the belt-shaped heater wire extends.

In the heating element 46 formed as described above, the resistivity of the heating element 46 measured along the longitudinal direction of the heating element 46 is relatively close to the resistivity of the heating element 46 measured along the direction orthogonal to the longitudinal direction of the heating element 46. Specifically, the magnitude of the ratio of the resistivity of the heating element 46 measured along the direction orthogonal to the longitudinal direction of the heating element 46, to the resistivity of the heating element 46 measured along the longitudinal direction of the heating element 46, is within the range of 0.9 to 1.1. This is because the short metal fibers are inclined relative to the longitudinal direction of the heating element 46 and the direction orthogonal to the longitudinal direction of the heating element 46.

Meanwhile, the resistivity of the heating element 46 measured along a direction making an angle of 45° with respect to the longitudinal direction of the heating element 46 at the surface of the heating element 46 is different from the resistivity of the heating element 46 measured along the longitudinal direction of the heating element 46. Specifically, the magnitude of the ratio of the resistivity of the heating element 46 measured along the longitudinal direction of the heating element 46, to the resistivity of the heating element 46 measured along the direction making an angle of 45° with respect to the longitudinal direction of the heating element 46 at the surface of the heating element 46, is not greater than 0.8 or not less than 1.2. This is because the short metal fibers generally extend along a direction making an angle within the range of 30° to 60° with respect to the longitudinal direction of the heating element 46.

In such a heating element 46, the metal fibers are inhibited from being oriented in the longitudinal direction of the heating element 46 or the direction orthogonal to the longitudinal direction, that is, the direction in which the belt-shaped heater wire extends. Therefore, non-uniform electrical conductivity is inhibited from occurring when a current is applied to the heating element 46, and thus heat generation can be inhibited from being non-uniform on a part of the heating element 46 when a current is applied to the lead wires 48 of the heater 40.

FIG. 7 and FIG. 8 are each a diagram illustrating a conventional method for cutting the metal fiber sheet 32. In the method for cutting the metal fiber sheet 32 shown in FIG. 7, the metal fiber sheet 32 unwound from the winding part 30 is cut into a rectangular shape that includes a first side extending along the sheetmaking direction (indicated by an arrow in FIG. 7) and a second side orthogonal to the first side. At this time, the first side in the rectangle is made longer than the second side. In this case, since the short metal fibers are oriented in the sheetmaking direction in the metal fiber sheet 32, the short metal fibers are also oriented along the first side in a metal fiber sheet 34p cut into the rectangular shape. Therefore, when the metal fiber sheet 34p is cut into a spiral shape to produce a heating element, the short metal fibers are oriented in the longitudinal direction of the heating element. Due to this, non-uniform electrical conductivity may occur when a current is applied to the heating element, and heat generation may be non-uniform depending on a part of the heating element.

In the method for cutting the metal fiber sheet 32 shown in FIG. 8, the metal fiber sheet 32 unwound from the winding part 30 is cut into a rectangular shape that includes a first side orthogonal to the sheetmaking direction (indicated by an arrow in FIG. 8) and a second side orthogonal to the first side. At this time, the first side in the rectangle is made longer than the second side. In this case as well, since the short metal fibers are oriented in the sheetmaking direction in the metal fiber sheet 32, the short metal fibers are also oriented along the second side in a metal fiber sheet 34q cut into the rectangular shape. Therefore, when the metal fiber sheet 34q is cut into a spiral shape to produce a heating element, the short metal fibers are oriented in a direction orthogonal to the longitudinal direction of the heating element. Due to this, non-uniform electrical conductivity may occur when a current is applied to the heating element, and heat generation may be non-uniform depending on a part of the heating element.

As described above, the heating element 46 of the present embodiment is composed of the belt-shaped heater wire, and the heater wire is configured such that the short metal fibers are at least partially bonded to each other. In addition, the magnitude of the ratio of the resistivity of the heating element 46 measured along a second direction (the up-down direction in FIG. 4) orthogonal to the longitudinal direction of the heating element 46, to the resistivity of the heating element 46 measured along a first direction (the right-left direction in FIG. 4) which is the longitudinal direction of the heating element 46, is within the range of 0.9 to 1.1. In addition, the magnitude of the ratio of the resistivity of the heating element 46 measured along the first direction, to the resistivity of the heating element measured along a third direction (an oblique direction in FIG. 4) making an angle of 45° with respect to the first direction at the surface of the heating element 46, is not greater than 0.8 or not less than 1.2. In such a heating element 46, the short metal fibers are oriented along the third direction and are not oriented along the first direction or the second direction. Therefore, non-uniform electrical conductivity is inhibited from occurring when a current is applied to the heating element 46, and thus heat generation can be inhibited from being non-uniform on a part of the heating element 46 when a current is applied to the lead wires 48 of the heater 40.

In the heater modules 1, 2, and 3 of the present embodiment, since heat generation can be inhibited from being non-uniform on a part of the heating element 46 when a current is applied to the lead wires 48 of the heater 40, the to-be-heated fluid can be uniformly heated by the heater 40, and thus occurrence of non-uniform heating can be prevented.

Specifically, in the heater module 1 according to the first example shown in FIG. 1, after the temperature of the to-be-heated fluid is adjusted to a temperature within the predetermined range by the temperature regulator 50, the to-be-heated fluid is heated by the heater 40 such that the temperature of the to-be-heated fluid becomes a temperature within the predetermined narrow range. At this time, the to-be-heated fluid can be uniformly heated by the heater 40 including the heating element 46 having the above-described features, and thus occurrence of non-uniform heating can be prevented.

In the heater module 2 according to the second example shown in FIG. 2, after the to-be-heated fluid is heated by the heater 40 such that the temperature of the to-be-heated fluid becomes a temperature within the predetermined narrow range, the temperature of the to-be-heated fluid is adjusted to a temperature within the predetermined range by the temperature regulator 50. In this case, the to-be-heated fluid can be uniformly heated by the heater 40 including the heating element 46 having the above-described features, and thus occurrence of non-uniform heating can be prevented.

In the heater module 3 according to the third example shown in FIG. 3, after the temperature of the to-be-heated fluid is adjusted to a temperature within the predetermined range by the temperature regulator 50 and the to-be-heated fluid is uniformly heated by the heater 40 such that the temperature of the to-be-heated fluid becomes a temperature within the predetermined narrow range, the temperature of the to-be-heated fluid is further adjusted to a temperature within the predetermined range by the temperature regulator 50. In this case, the to-be-heated fluid can be uniformly heated by the heater 40 including the heating element 46 having the above-described features, and thus occurrence of non-uniform heating can be prevented.

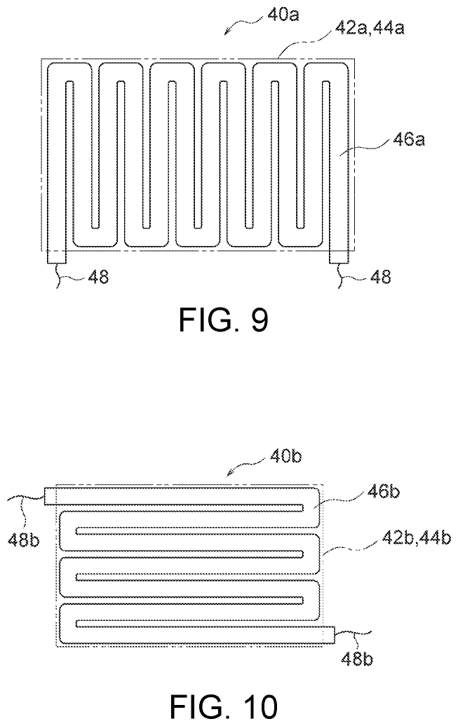

In the present embodiment, the heating element and the heater are not limited to a heating element and a heater having the shapes shown in FIG. 4. As the heating element and the heater, a heating element and a heater having configurations shown in FIG. 9 to FIG. 11 may be used.

A heater 40a according to a modification shown in FIG. 9 includes a pair of nonwoven fabric sheets 42a and 44a, a heating element 46a interposed between the pair of nonwoven fabric sheets 42a and 44a, and lead wires 48a attached to both end portions of the heating element 46a, respectively. In such a heater 40a, the heating element 46a is composed of a belt-shaped heater wire, and the heater wire is configured such that short metal fibers are at least partially bonded to each other. In addition, the magnitude of the ratio of the resistivity of the heating element 46a measured along a second direction orthogonal to the longitudinal direction of the heating element 46a, to the resistivity of the heating element 46a measured along a first direction which is the longitudinal direction of the heating element 46a, is within the range of 0.9 to 1.1. In addition, the magnitude of the ratio of the resistivity of the heating element 46a measured along the first direction, to the resistivity of the heating element measured along a third direction making an angle of 45° with respect to the first direction at the surface of the heating element 46a, is not greater than 0.8 or not less than 1.2. In the configuration shown in FIG. 9, the longitudinal direction of the heating element 46a corresponds to the right-left direction in FIG. 9, and the direction orthogonal to the longitudinal direction of the heating element 46a corresponds to the up-down direction in FIG. 9. In addition, the belt-shaped heater wire constituting the heating element 46a generally extends in the direction (i.e., the up-down direction in FIG. 9) orthogonal to the longitudinal direction of the heating element 46a.

A heater 40b according to another modification shown in FIG. 10 includes a pair of nonwoven fabric sheets 42b and 44b, a heating element 46b interposed between the pair of nonwoven fabric sheets 42b and 44b, and lead wires 48b attached to both end portions of the heating element 46b, respectively. In such a heater 40b, the heating element 46b is composed of a belt-shaped heater wire, and the heater wire is configured such that short metal fibers are at least partially bonded to each other. In addition, the magnitude of the ratio of the resistivity of the heating element 46b measured along a second direction orthogonal to the longitudinal direction of the heating element 46b, to the resistivity of the heating element 46b measured along a first direction which is the longitudinal direction of the heating element 46b, is within the range of 0.9 to 1.1. In addition, the magnitude of the ratio of the resistivity of the heating element 46b measured along the first direction, to the resistivity of the heating element measured along a third direction making an angle of 45° with respect to the first direction at the surface of the heating element 46b, is not greater than 0.8 or not less than 1.2. In the configuration shown in FIG. 10, the longitudinal direction of the heating element 46b corresponds to the right-left direction in FIG. 10, and the direction orthogonal to the longitudinal direction of the heating element 46b corresponds to the up-down direction in FIG. 10. In addition, the belt-shaped heater wire constituting the heating element 46b generally extends in the longitudinal direction of the heating element 46b (i.e., the right-left direction in FIG. 10).

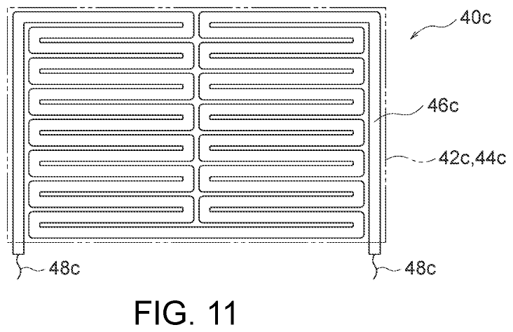

A heater 40c according to still another modification shown in FIG. 11 includes a pair of nonwoven fabric sheets 42c and 44c, a heating element 46c interposed between the pair of nonwoven fabric sheets 42c and 44c, and lead wires 48c attached to both end portions of the heating element 46c, respectively. In such a heater 40c, the heating element 46c is composed of a belt-shaped heater wire, and the heater wire is configured such that short metal fibers are at least partially bonded to each other. In addition, the magnitude of the ratio of the resistivity of the heating element 46c measured along a second direction orthogonal to the longitudinal direction of the heating element 46c, to the resistivity of the heating element 46c measured along a first direction which is the longitudinal direction of the heating element 46c, is within the range of 0.9 to 1.1. In addition, the magnitude of the ratio of the resistivity of the heating element 46c measured along the first direction, to the resistivity of the heating element measured along a third direction making an angle of 45° with respect to the first direction at the surface of the heating element 46c, is not greater than 0.8 or not less than 1.2. In the configuration shown in FIG. 11, the longitudinal direction of the heating element 46c corresponds to the right-left direction in FIG. 11, and the direction orthogonal to the longitudinal direction of the heating element 46c corresponds to the up-down direction in FIG. 11. In addition, the belt-shaped heater wire constituting the heating element 46c generally extends in the longitudinal direction of the heating element 46c (i.e., the right-left direction in FIG. 11) and the direction (i.e., the up-down direction in FIG. 11) orthogonal to the longitudinal direction.

In the heating elements 46a, 46b, and 46c shown in FIG. 9 to FIG. 11 as well, as in the heating element 46 shown in FIG. 4, the short metal fibers are oriented along the third direction and are not oriented along the first direction or the second direction. Therefore, non-uniform electrical conductivity is inhibited from occurring when a current is applied to the heating elements 46a, 46b, and 46c, and thus heat generation can be inhibited from being non-uniform due to parts of the heating elements 46a, 46b, and 46c when a current is applied to the lead wires 48a, 48b, and 48c of the heaters 40a, 40b, and 40c.

Although the planar heater and heating element have been described above, the present embodiment is not limited thereto. As the heater and the heating element according to the present embodiment, a heater and a heating element having a three-dimensional shape or a heater and a heating element having a curved surface shape obtained by curving a planar shape may be used.

The metal fiber sheet before being cut into a quadrangular shape is not limited to a metal fiber sheet produced by the wet-type sheetmaking machine 10 shown in FIG. 5. As the metal fiber sheet before being cut into a quadrangular shape, a sheet produced by a sheetmaking method different from the above-described method may be used as long as the sheet can be produced by sheetmaking.

### EXAMPLES

Hereinafter, the present invention will be described in more detail by means of examples and comparative examples.

### First Example 1

A metal fiber sheet 32 was manufactured using the wet-type sheetmaking machine 10 having the configuration shown in FIG. 5. Specifically, 1.0 m³ of water was fed into the headbox 12, and then polyethylene fibers having a mass that was a ratio of 45.2% to the water was fed into the headbox 12. After feeding, the mixture was stirred, and the dispersion state was checked. Then, 1.5 kg of stainless steel fibers having a fiber diameter of 8 μm and a fiber length of 3 mm was fed into the headbox 12, and after feeding, the mixture was stirred. Then, 7.54 kg of pulp was fed into the headbox 12, and after feeding, the mixture was stirred. Then, 0.044 kg of polyvinyl alcohol was fed into the headbox 12. After feeding, the mixture was stirred, and the dispersion state was checked. Then, polyacrylamide (Acrypers (registered trademark) 1.0%) having a solid content of 1% was fed into the headbox 12 as a dispersant. After feeding, the mixture was stirred, and the dispersion state was checked. Then, water was added to the headbox 12 to set the storage amount of the slurry in the headbox 12 to be 2.0 m³.

Then, the slurry was supplied from the headbox 12 onto the conveyor 15, and was made into a sheet by the sheetmaking part 14. At that time, the sheetmaking speed (that is, the movement speed of the conveyor 15) was 2 m/min, and the flow rate of the slurry supplied from the headbox 12 onto the conveyor 15 was 69.3 L/min. Then, the sheet made on the conveyor 15 was dehydrated by the dehydrating part 16. Specifically, moisture was sucked from the sheet by the suction box 18. Then, the sheet on the conveyor 15 was pressed by the nip rollers 22 at the pressing part 20. Then, the sheet on the conveyor 15 was dried by the Yankee dryer roll 26 and the after-dryer roll 28 at 120° C. at the drying part 24. Then, the sheet dried by the drying part 24 was wound by the winding part 30. Before or after the sheet was wound by the winding part 30, the sheet was sintered in a vacuum or a non-oxidizing atmosphere at 1120° C.

Then, the metal fiber sheet 32 was unwound from the winding part 30, and the unwound metal fiber sheet 32 was cut into a rectangular shape. At this time, a first side of the rectangle was formed so as to make an angle of 45° with respect to the sheetmaking direction, and a second side shorter than the first side was formed so as to make an angle of 90° with respect to the first side. That is, the second side was also formed so as to make an angle of 45° with respect to the sheetmaking direction. A metal fiber sheet 34 thus cut into the rectangular shape was further cut into a spiral shape to produce a heating element having the same configuration as the heating element 46 having the configuration shown in FIG. 5. Such a heating element was interposed between insulating and heat-conductive nonwoven fabric sheets, thereby manufacturing a heater. This heater was placed upstream of a temperature regulator in a flow direction of water which is a to-be-heated fluid, to produce a heater module.

The resistivity of the heating element of such a heater was measured in each of the longitudinal direction of the heating element (first direction), a direction (second direction) orthogonal to the longitudinal direction, and a direction (third direction) making an angle of 45° with respect to the longitudinal direction, in accordance with the JIS C 2525 standard. Specifically, the resistivity of a material is a value specific to the material, and can be determined by applying a current to the material and measuring the potential difference between electrodes separated by a predetermined distance. Specifically, a resistance value (Ω) was measured by using Loresta manufactured by Nittoseiko Analytech Co., Ltd. and pressing a two-point probe against arbitrary points on the heating element along each of the longitudinal direction of the heating element and the direction orthogonal to the longitudinal direction. A value obtained by dividing the measured resistance value (Ω) by the distance between the probes is resistivity (Ω/mm).

The in-plane temperature difference was measured when a current was applied to the heating element when the temperature of the ambient environment was room temperature. The case where the in-plane temperature difference was not higher than 5° C. was evaluated as “good”, and the case where the in-plane temperature difference exceeded 5° C. was evaluated as “non-uniform heat generation”.

### Examples 2 to 10

The method for producing a metal fiber sheet 32 was the same as in Example 1, but the metal fiber sheet 32 was unwound from the winding part 30, and when the unwound metal fiber sheet 32 was cut into a rectangular shape, a first side of the rectangle was formed so as to make an angle of 50°, 52°, 54°, 56°, 58°, 40°, 38°, 36°, or 34° with respect to the sheetmaking direction, and a second side shorter than the first side was formed so as to make an angle of 90° with respect to the first side. That is, the second side was formed so as to make an angle of 40°, 38°, 36°, 34°, 32°, 50°, 52°, 54°, or 56° with respect to the sheetmaking direction. Then, a metal fiber sheet 34 cut into the rectangular shape was further cut into a spiral shape to produce a heating element having the same configuration as the heating element 46 having the configuration shown in FIG. 5. The resistivity of such a heating element was measured in each of the first direction, the second direction, and the third direction of the heating element by the same method as in Example 1. In addition, the in-plane temperature difference was measured when a current was applied to the heating element when the temperature of the ambient environment was room temperature, and whether or not heat generation was uniform was evaluated.

### Comparative Example 1

The method for producing a metal fiber sheet 32 was the same as in Example 1, but when the metal fiber sheet 32 was unwound from the winding part 30, and the unwound metal fiber sheet 32 was cut into a rectangular shape, the metal fiber sheet 32 unwound from the winding part 30 was cut into a rectangular shape including a first side orthogonal to the sheetmaking direction and a second side orthogonal to the first side as shown in FIG. 8. At this time, the first side of the rectangle was made longer than the second side. That is, when the unwound metal fiber sheet 32 was cut into a rectangular shape, the first side of the rectangle was formed so as to make an angle of 90° with respect to the sheetmaking direction, and the second side was formed so as to make an angle of 0° with respect to the sheetmaking direction. The resistivity of such a heating element was measured in the longitudinal direction of the heating element and a direction orthogonal to the longitudinal direction by the same method as in Example 1. In addition, the in-plane temperature difference was measured when a current was applied to the heating element when the temperature of the ambient environment was room temperature, and whether or not heat generation was uniform was evaluated.

### Comparative Example 2

The method for producing a metal fiber sheet 32 was the same as in Example 1, but when the metal fiber sheet 32 was unwound from the winding part 30, and the unwound metal fiber sheet 32 was cut into a rectangular shape, the metal fiber sheet 32 unwound from the winding part 30 was cut into a rectangular shape including a first side extending along the sheetmaking direction and a second side orthogonal to the first side as shown in FIG. 7. At this time, the first side of the rectangle was made longer than the second side. That is, when the unwound metal fiber sheet 32 was cut into a rectangular shape, the first side of the rectangle was formed so as to make an angle of 0° with respect to the sheetmaking direction, and the second side was formed so as to make an angle of 90° with respect to the sheetmaking direction. The resistivity of such a heating element was measured in the longitudinal direction of the heating element and a direction orthogonal to the longitudinal direction by the same method as in Example 1. In addition, the in-plane temperature difference was measured when a current was applied to the heating element when the temperature of the ambient environment was room temperature, and whether or not heat generation was uniform was evaluated.

### <Evaluation>

The resistivity of each of the heating elements according to Examples 1 to 10 and Comparative Examples 1 and 2 in the longitudinal direction (first direction) of the heating element, the direction (second direction) orthogonal to the longitudinal direction, and the direction (third direction) making an angle of 45° with respect to the longitudinal direction is shown in the following tables. In addition, the ratio (first ratio) of the resistivity of the heating element measured along the second direction, to the resistivity of the heating element measured along the first direction, and the ratio (second ratio) of the resistivity of the heating element measured along the first direction, to the resistivity of the heating element measured along the third direction, are shown in the following tables. Moreover, for the heating elements according to Examples 1 to 10 and Comparative Examples 1 and 2, the evaluation of whether or not heat was uniformly generated when a current was applied is also shown in the following tables.

TABLE 1

| | Ex. 1 | Ex. 2 | Ex. 3 | Ex. 4 | Ex. 5 | Ex. 6 |
|---|---|---|---|---|---|---|
| Angle of first side of | 45° | 50° | 52° | 54° | 56° | 58° |
| rectangle with respect | | | | | | |
| to sheetmaking | | | | | | |
| direction | | | | | | |
| Resistance value in | 0.59 | 0.58 | 0.57 | 0.58 | 0.59 | 0.59 |
| first direction (Ω/mm) | | | | | | |
| Resistance value in | 0.60 | 0.59 | 0.56 | 0.59 | 0.58 | 0.60 |
| second direction | | | | | | |
| (Ω/mm) | | | | | | |
| Resistance value in | 0.43 | 0.48 | 0.46 | 0.45 | 0.44 | 0.42 |
| third direction (Ω/mm) | | | | | | |
| First ratio | 1.02 | 1.02 | 0.98 | 1.02 | 0.98 | 1.02 |
| Second ratio | 1.37 | 1.21 | 1.24 | 1.29 | 1.34 | 1.40 |
| In-plane temperature | Good | Good | Good | Good | Good | Good |
| difference | | | | | | |

TABLE 2

| | Ex. 7 | Ex. 8 | Ex. 9 | Ex. 10 | Comp. Ex. 1 | Comp. Ex. 2 |
|---|---|---|---|---|---|---|
| Angle of first side of | 40° | 38° | 36° | 34° | 90° | 0 |
| rectangle with respect | | | | | | |
| to sheetmaking | | | | | | |
| direction | | | | | | |
| Resistance value in | 0.59 | 0.59 | 0.59 | 0.65 | 0.62 | 0.58 |
| first direction (Ω/mm) | | | | | | |
| Resistance value in | 0.57 | 0.56 | 0.55 | 0.59 | 0.48 | 0.57 |
| second direction | | | | | | |
| (Ω/mm) | | | | | | |
| Resistance value in | 0.43 | 0.43 | 0.43 | 0.47 | 0.49 | 0.49 |
| third direction (Ω/mm) | | | | | | |
| First ratio | 0.97 | 0.95 | 0.93 | 0.91 | 0.77 | 0.98 |
| Second ratio | 1.37 | 1.37 | 1.37 | 1.38 | 1.27 | 1.18 |
| In-plane temperature | Good | Good | Good | Good | Non-uniform | Non-uniform |
| difference | | | | | heat | heat |
| | | | | | generation | generation |

As shown in Table 1 and Table 2, in each of the heating elements according to Examples 1 to 10, the magnitude of the first ratio was within the range of 0.9 to 1.1, while the second ratio was not greater than 0.8 or not less than 1.2. In addition, the in-plane temperature difference was not higher than 5° C. when a current was applied to the heating element when the temperature of the ambient environment was room temperature. On the other hand, in each of the heating elements according to Comparative Examples 1 and 2, the magnitude of the first ratio was not greater than 0.9 or not less than 1.1, or the magnitude of the second ratio was within the range of 0.8 to 1.2. In addition, the in-plane temperature difference exceeded 5° C. when a current was applied to the heating element when the temperature of the ambient environment was room temperature.

1. A heating element constituting a belt-shaped heater wire, wherein
the heater wire is configured such that short metal fibers are at least partially bonded to each other,
a magnitude of a ratio of resistivity of the heating element measured along a second direction orthogonal to a longitudinal direction of the heating element, to resistivity of the heating element measured along a first direction which is the longitudinal direction of the heating element, is within a range of 0.9 to 1.1, and
a magnitude of a ratio of the resistivity of the heating element measured along the first direction, to resistivity of the heating element measured along a third direction making an angle of 45° with respect to the first direction at a surface of the heating element, is not greater than 0.8 or not less than 1.2.

2. The heating element according to claim 1, wherein the heater wire includes at least either a portion extending in the longitudinal direction of the heating element or a portion orthogonal to the longitudinal direction of the heating element.

3. The heating element according to claim 1, wherein the heater wire has a spiral shape.

4. A heater comprising:
the heating element according to claim 1; and
an insulator stacked on at least one surface of the heating element.

5. A heater module comprising the heater according to claim 4 and a temperature regulator(s), wherein
the heater and the temperature regulator(s) are placed so as to be aligned in series in a flow direction of a to-be-heated fluid.

6. The heater module according to claim 5, wherein the heater is placed downstream of the temperature regulator in the flow direction of the to-be-heated fluid.

7. The heater module according to claim 5, wherein the heater is placed upstream of the temperature regulator in the flow direction of the to-be-heated fluid.

8. The heater module according to claim 5, wherein the temperature regulator, the heater, and the temperature regulator are placed in this order from an upstream side in the flow direction of the to-be-heated fluid.

9. The heater module according to claim 5, wherein the heating element is a heating element manufactured by: producing a metal fiber sheet by sheetmaking; and cutting the metal fiber sheet produced by sheetmaking, into a quadrangular shape including a side extending in a fourth direction making an angle within a range of 30° to 60° with respect to a sheetmaking direction and a side extending in a fifth direction making an angle within a range of 80° to 100° with respect to the fourth direction.

10. The heater module according to claim 9, wherein the heating element is a heating element manufactured by cutting a metal fiber sheet having a quadrangular shape and obtained by a cutting step to produce a belt-shaped heater wire, and the heater wire includes at least either a portion extending along a longitudinal direction of the metal fiber sheet having a quadrangular shape or a portion orthogonal to the longitudinal direction of the metal fiber sheet.

11. A method for manufacturing a heating element constituting a belt-shaped heater wire, the method comprising:
a step of producing a metal fiber sheet by sheetmaking; and
a step of cutting the metal fiber sheet produced by sheetmaking, into a quadrangular shape including a side extending in a fourth direction making an angle within a range of 30° to 60° with respect to a sheetmaking direction and a side extending in a fifth direction making an angle within a range of 80° to 100° with respect to the fourth direction.

12. The method for manufacturing the heating element according to claim 11, further comprising a step of cutting a metal fiber sheet having a quadrangular shape and obtained by the cutting step to produce a belt-shaped heater wire, wherein
the heater wire includes at least either a portion extending along a longitudinal direction of the metal fiber sheet having a quadrangular shape or a portion orthogonal to the longitudinal direction of the metal fiber sheet.
